(19) United States
(12) Patent Application Publication
(10) Pub. No.: US 2024/0370520 A1
(43) Pub. Date: Nov. 7, 2024

(54) MULTIPLIER-LESS CONVOLUTION BASED NEURAL PROCESSING UNIT AND METHOD OF OPERATING THE SAME

(71) Applicant: OMNIVISION TECHNOLOGIES, INC., Santa Clara, CA (US)

(72) Inventors: WEI JUN KOH, Singapore (SG); SANGEETHA BABU, Singapore (SG); CHIN TONG THIA, Singapore (SG)

(21) Appl. No.: 18/310,104

(22) Filed: May 1, 2023

(51) Int. Cl. G06F 17/15; G06F 5/01; G06F 7/499; G06N 3/0464

(52) U.S. Cl. CPC G06F 17/15; G06F 5/01; G06F 7/49942; G06N 3/0464

(57) ABSTRACT

A method for convolution calculation in a neural network is provided. The method comprises: decomposing each weight into multiple sub-weights, each with only one valid bit, representing different bit significance (bit plane); accumulating input feature map units corresponding to each of the sub-weights with the same bit significance to obtain intermediate sums; shifting each of the intermediate sums according to the bit significance of the corresponding sub-weights to obtain shifted intermediate sums; and accumulating the shifted intermediate sums.

### BACKGROUND OF THE INVENTION

### 1. Field of the Invention

The present disclosure relates to a neural processing unit, and more particularly, to a multiplier-less convolution based neural processing unit.

### 2. Description of the Related Art

Neural processing units (NPUs) use a large array of multiplier-accumulator (MAC) units to accelerate convolutional neural networks (CNNs). The MAC units in NPUs perform accumulations of multiplications between input feature maps (IFMs) and convolution weights of a CNN model to produce convolution output feature maps (OFMs). A basic MAC unit consists of a multiplier, an adder and an accumulator. A hardware accelerator uses a large number of MAC units to perform a convolution operation. However, multipliers of these MAC units contribute significantly to the gate count and power consumption.

### SUMMARY OF THE INVENTION

One aspect of the present disclosure provides a method for convolution calculation in a neural network. The method comprises: decomposing each weight into multiple sub-weights, each with only one valid bit, in a particular bit significance (bit plane); accumulating input feature map units corresponding to each of the sub-weights with the same valid bit to obtain intermediate sums; shifting each of the intermediate sums according to the bit significance of the corresponding sub-weights to obtain shifted intermediate sums; and accumulating the shifted intermediate sums.

Another aspect of the present disclosure provides an apparatus for convolution calculation in a neural network. The apparatus comprises: a computing device, a first accumulator, a shifter and a second accumulator. The computing device is configured to decompose each weight into multiple sub-weights, each with only one valid bit, in a particular bit significance (bit plane). The first accumulator is configured to accumulate input feature map units corresponding to each of the sub-weights with the same bit significance from the computing device to obtain intermediate sums. The shifter is configured to shift each of the intermediate sums according to the bit significance of the corresponding sub-weights from the computing device to obtain shifted intermediate sums. The second accumulator is configured to accumulate the shifted intermediate sums.

Another aspect of the present disclosure provides an arithmetic logic unit for a neural network. The arithmetic logic unit comprises: a first register, a first adder, a shifter, a second register and a second adder. The first adder is configured to add an input feature map unit with a first value stored in the first register and update the first value stored in the first register. The shifter is configured to shift an output of the register a predetermined number of bits. The second adder is configured to add an output of the shifter with a second value stored in the second register and update the second value stored in the second register.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, dimensions of the various features may be arbitrarily increased or reduced for clarity of discussion.

FIG. 1 illustrates a schematic diagram of a baseline multiply-accumulate (MAC) structure, in accordance with some embodiments of the present disclosure.

FIG. 2 illustrates detailed computations of the accumulations and multiplications of the baseline MAC structure, in accordance with some embodiments of the present disclosure.

FIG. 3 illustrates a schematic diagram of a multiplier-less convolution (MLC) MAC structure, in accordance with some embodiments of the present disclosure.

FIGS. 4A-4D illustrate detailed computations of the accumulations and multiplications of the MLC MAC structure, in accordance with some embodiments of the present disclosure.

FIG. 5 is a flow chart of a method for convolution calculation in a neural network, in accordance with some embodiments of the present disclosure.

FIG. 6 illustrates a time diagram of the accumulator value, in accordance with some embodiments of the present disclosure.

FIG. 7 illustrates a time diagram of the accumulator value, in accordance with some embodiments of the present disclosure.

FIG. 8 illustrates a diagram showing the comparison between the baseline approach and the MLC approach, in accordance with some embodiments of the present disclosure.

### DETAILED DESCRIPTION OF THE DISCLOSURE

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures.

As used herein, although the terms such as “first,” “second” and “third” describe various elements, components, regions, layers and/or sections, these elements, components, regions, layers and/or sections should not be limited by these terms. These terms may be only used to distinguish one element, component, region, layer or section from another. The terms such as “first,” “second” and “third” when used herein do not imply a sequence or order unless clearly indicated by the context.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from normal deviation found in the respective testing measurements. Also, as used herein, the terms “substantially,” “approximately” and “about” generally mean within a value or range that can be contemplated by people having ordinary skill in the art. Alternatively, the terms “substantially,” “approximately” and “about” mean within an acceptable standard error of the mean when considered by one of ordinary skill in the art. People having ordinary skill in the art can understand that the acceptable standard error may vary according to different technologies. Other than in the operating/working examples, or unless otherwise expressly specified, all of the numerical ranges, amounts, values and percentages, such as those for quantities of materials, durations of times, temperatures, operating conditions, ratios of amounts, and the likes thereof disclosed herein, should be understood as modified in all instances by the terms “substantially,” “approximately” or “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

Neural networks are at the heart of deep learning algorithms. They consist of node layers, containing an input layer, one or more hidden layers, and an output layer. Each node connects to another and has an associated weight and threshold. If the output of any individual node is above the specified threshold value, that node is activated, sending data to the next layer of the network. Otherwise, no data is passed along to the next layer of the network.

Convolutional neural networks (CNNs) are more often utilized for classification and computer vision tasks. Prior to CNNs, manual, time-consuming feature extraction methods were used to identify objects in images. However, CNNs now provide a more scalable approach to image classification and object recognition tasks, leveraging principles from linear algebra, specifically matrix multiplication, to identify patterns within an image. That said, they can be computationally demanding, requiring graphical processing units (GPUs) to train models.

CNNs are distinguished from other neural networks by their superior performance with image, speech, or audio signal inputs. They have three main types of layers: convolution layer, pooling layer and fully-connected layer. The convolutional layer is the core building block of a CNN, and it is where the majority of computation occurs. The convolutional layer requires a few components: input data, a filter, and a feature map. If the input is a color image made up of a matrix of pixels in three-dimension (3D), the input data will have three dimensions—a height, a width, and a depth—which correspond to RGB in an image. The filter is also known as a feature detector or a kernel, which will move across the respective fields of the image, checking if the feature is present. Such process is known as a convolution.

The filter is a 3D array of weights, which represents part of the image. The filter is applied to an area of the image, and a multiplied product is calculated between the input data and the filter. The multiplied product is then fed and accumulated into an output array. Afterwards, the filter shifts by a stride, repeating the process until the filter has swept across the entire image. The final output from the series of multiplied products from the input data and the filter is known as a feature map, an activation map, or a convolved feature. The hardware unit that performs such operation is known as a multiplier-accumulator (MAC) unit. The operation itself is also often known as a MAC operation. The MAC operation modifies an accumulator a←a+(b×c).

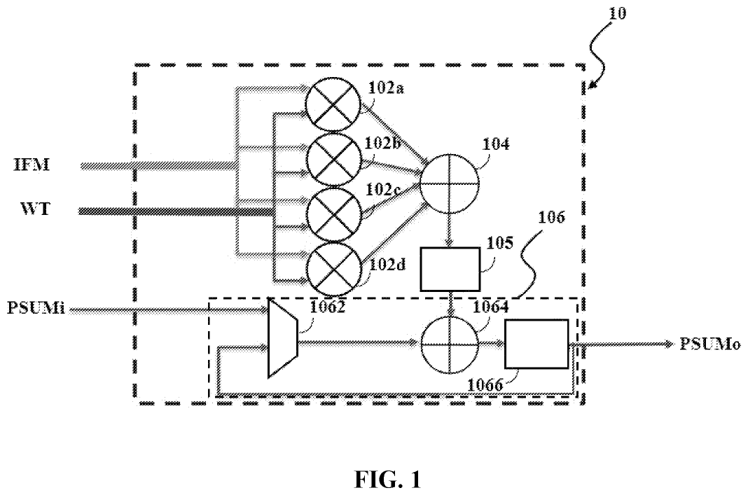

FIG. 1 illustrates a schematic diagram of a baseline MAC structure, in accordance with some embodiments of the present disclosure. FIG. 1 shows an example atomic MAC unit 10 consisting of four multipliers 102a-d, an adder 104, a register 105, and an accumulator 106 is used in the baseline MAC structure as shown in FIG. 1. In accordance with some embodiments of the disclosure, each processing element (PE) can consist of 4×4 atomic MAC units 10 as shown in FIG. 1. The IFM data array IFM is multiplied with the corresponding weight array WT and is accumulated with the partial sum input PSUMi to produce the partial sum output PSUMo.

In accordance with some embodiments of the disclosure, the accumulator 106 includes a multiplexer 1062, an adder 1064 and a register 1066. The adder 1064 adds the output of the register 105 and the output of the multiplexer 1062 (i.e., the partial sum input PSUMi from an adjacent PE or the previous partial sum output PSUMo) and outputs the result to the register 1066.

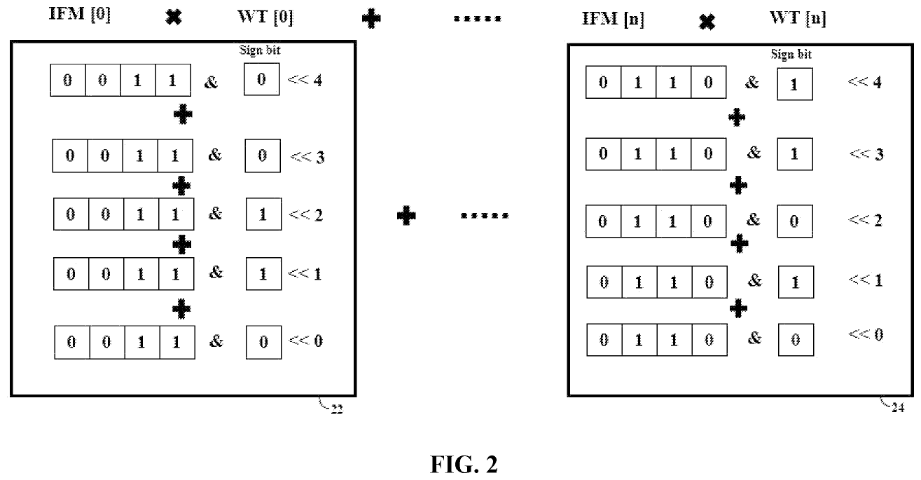

FIG. 2 illustrates detailed computations of the accumulations and multiplications of the baseline MAC structure, in accordance with some embodiments of the present disclosure.

FIG. 2 shows that each element of the IFM data array IFM is multiplied with the corresponding element in the weight array WT. For example, block 22 shows the multiplication of IFM [0]=[0, 0, 1, 1] and WT [0]=[0, 0, 1, 1, 0]. In such example, a logic AND operation (&) is performed between IFM [0] and the most significant bit (corresponding to a sign bit) of WT [0], and the result is shifted left by four bits; a logic AND operation (&) is performed between IFM [0] and the second most significant bit of WT [0] (corresponding to 2³), and the result is shifted left by three bits; a logic AND operation (&) is performed between IFM [0] and the third most significant bit of WT [0] (corresponding to 2²), and the result is shifted left by two bits; a logic AND operation (&) is performed between IFM [0] and the fourth most significant bit of WT [0] (corresponding to 2¹), and the result is shifted left by one bit; and a logic AND operation (&) is performed between IFM [0] and the least significant bit of WT [0] (corresponding to 2⁰), and the result is shifted by zero bits. The shifted results of the above are added together so as to obtain the multiplication product of IFM [0]=[0, 0, 1, 1] and WT [0]=[0, 0, 1, 1, 0]. Correspondingly, block 24 shows the multiplication of IFM [n]=[0, 1, 1, 0] and WT [n]=[1, 1, 0, 1, 0]. The computation can be performed in a manner similar to that mentioned above for block 22. After each element of the IFM data array IFM is multiplied with the corresponding element in the weight array WT, all of the multiplication products are added together to obtain the multiplication product of the IFM data array IFM and the weight array WT.

However, the multiplications in the MAC units often consume a significant portion of total power in an NPU. Multipliers of these MAC units contribute significantly to the gate count and power consumption.

Additionally, the convolution weights of CNN models often consist of significantly more zero bits than one bits (e.g., an 8-bit weight of value 0x40 consists of only 1 bit of one and 7 bits of zero). Accordingly, much power is wasted in computing zero bits in the weights.

Moreover, the convolution weights in most CNN models are evenly distributed among positive values and negative values and a majority of the convolution weights have a small magnitude. Accordingly, the IFM data also tend to lean towards a smaller magnitude along the layers. Therefore, the outputs of the adders/accumulators often toggle between small-magnitude positive values and small-magnitude negative values, which cause a lot of bit-toggling in a signed binary number system.

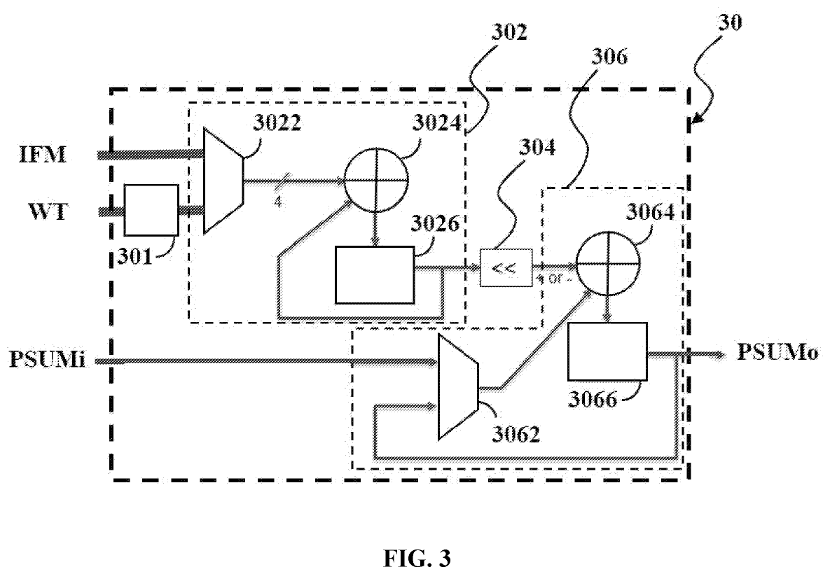

FIG. 3 illustrates a schematic diagram of a multiplier-less convolution (MLC) MAC structure, in accordance with some embodiments of the present disclosure.

The MLC MAC structure transforms the “multiply+accumulate” operation into an “addition+shift+accumulation” operation, which replaces multiplications with shifters where only effective bits of the weight array WT are computed. The transformation is done by decomposition of each weight into multiple sub-weights, each with only one valid bit, in a particular bit significance (bit plane). For example, a weight of +5 is decomposed into 2 sub-weights with binary codes of 8′b0000_0100 and 8′b0000_0001. For an unsigned 8-bit weight model, the maximum is up to 8 unique sub-weights for the whole model. Such bit-plane weight processing forms the basis of the invention.

FIG. 3 shows an apparatus 30 for convolution calculation in a neural network. The apparatus 30 comprises: a computing device 301, a first accumulator 302, a shifter 304 and a second accumulator 306. The computing device 301 is configured to decompose each weight into multiple sub-weights each with only one valid bit, in a particular bit significance (bit plane). The first accumulator 302 is configured to accumulate input feature map units corresponding to each of the sub-weights with the same valid bit from the computing device 301 to obtain intermediate sums. The shifter 304 is configured to shift each of the intermediate sums according to the bit significance of the corresponding sub-weights from the computing device 301 to obtain shifted intermediate sums. The second accumulator 306 is configured to accumulate the shifted intermediate sums.

In accordance with some embodiments of the disclosure, each weight further comprises a sign bit, wherein the sign bit can be logic zero (represent positive value) or logic one (represent negative value). In accordance with some embodiments of the disclosure, the first accumulator 302 accumulates the input feature map units corresponding to each of the sub-weights with the same bit significance and decomposed from the weights with the sign bit of logic zero (positive value) to obtain a first set of intermediate sums of the intermediate sums. In accordance with some embodiments of the disclosure, the first accumulator 302 accumulates the input feature map units corresponding to each of the sub-weights with the same bit significance and decomposed from the weights with the sign bit of logic one (negative value) to obtain a second set of intermediate sums of the intermediate sums.

In accordance with some embodiments of the disclosure, the second accumulator further: accumulates the shifted intermediate sums of the first set of intermediate sums from the shifter to obtain a first sum; and after obtaining the first sum, accumulating the shifted intermediate sums of the second set of intermediate sums from the shifter to the first sum to obtain a second sum.

In accordance with some embodiments of the disclosure, the one valid bit is logic one and the bits other than the valid bit of each of the sub-weights are logic zero. In accordance with some embodiments of the disclosure, the weights and the sub-weights are binary codes including the same number of bits. In accordance with some embodiments of the disclosure, if the valid bit of the corresponding sub-weights of one of the intermediate sums is the bit representing 2^{N}, then the intermediate sum is shifted N digits by the shifter 304. In accordance with some embodiments of the disclosure, the weights with the sign bit of logic one are negative value in logic two's complement representation. In accordance with some embodiments of the disclosure, the computing device 301 decomposes each weight into N sub-weights if the weight include N bits of logic one.

According to another aspect of the present disclosure, FIG. 3 shows an arithmetic logic unit 30 for a neural network. The arithmetic logic unit 30 comprises: a first register 3026, a first adder 3024, a shifter 304, a second register 3066 and a second adder 3064. The first adder 3024 is configured to add an input feature map unit with a first value stored in the first register 3026 and update the first value stored in the first register 3026. The shifter 304 is configured to shift an output of the register 3066 a predetermined number of bits. The second adder 3064 is configured to add an output of the shifter 304 with a second value stored in the second register 3066 and update the second value stored in the second register 3066.

In accordance with some embodiments of the disclosure, the arithmetic logic unit 30 further comprises a first multiplexer 3022 configured to select the input feature map unit from input feature map data and forward the input feature map unit to the first adder 3024. In accordance with some embodiments of the disclosure, the arithmetic logic unit 30 further comprises a second multiplexer 3062 configured to select between an output of the second register 3066 and a partial sum input PSUMi from an adjacent arithmetic logic unit and forward it to the second adder 3064.

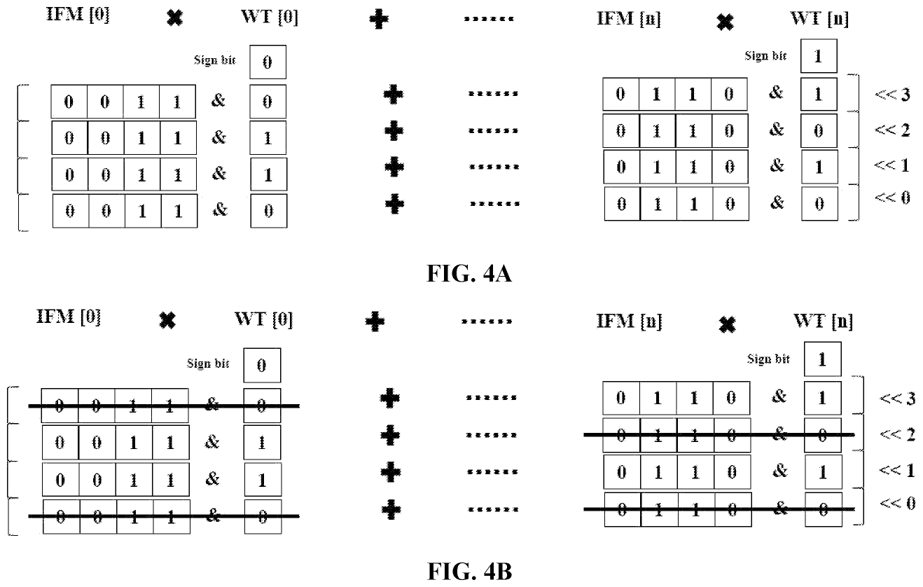

FIGS. 4A-4D illustrate detailed computations of the accumulations and multiplications of the MLC MAC structure, in accordance with some embodiments of the present disclosure.

According to FIG. 2, the partial sum is computed as follows:

$$P SUM = IFM [ 0 ] \times WT [ 0 ] + IFM [ 1 ] \times WT [ 1 ] + IFM [ 2 ] \times WT [ 2 ] + IFM [ 3 ] \times WT [ 3 ] + … + IFM [ n ] \times WT [ n ]$$

The equation can be factorized so that the IFM bits of the corresponding valid WT bit significant (bit plane) are added and stored before shifting. For example, if WT [0]=[0, 0, 0, 1], WT [1]=[0, 0, 1, 1], WT [2]=[0, 1, 0, 1] and WT [3]=[0, 0, 1, 1], then the equation can be factorized as follows:

$$PSUM = ( IFM [ 0 ] + IFM [ 1 ] + IFM [ 2 ] + IFM [ 3 ] + … ) << 0 + ( IFM [ 1 ] + IFM [ 3 ] + … ) << 1 + ( IFM [ 2 ] ) << 2 + …$$

Accordingly, the multiplications in the calculation can be removed and weight bits with zero magnitude can be skipped. Such approach also results in a reduced number of shifts compared to the baseline MAC structure since the shifting operation is done “after” the nth IFM addition.

FIG. 4A shows a computation for multiplying the IFM data array with the weight array. As shown in FIG. 4A, WT [0]=[0, 0, 1, 1, 0]. The logic AND operation (&) is performed between IFM [0] and each bit, except the sign bit, of WT [0]. Such operations are applied to the entire IFM data array and weight array. Then, the result corresponding to each bit position of WT [0] is respectively accumulated with the result corresponding to the same bit position of other weights (i.e., WT [1] . . . . WT [n]) to obtain an intermediate sum for each bit position. Each of the intermediate sums is then shifted according to the corresponding bit position. For example, a logic AND operation is performed between IFM [0] and the third most significant bit of WT [0] (corresponding to 2²), a logic AND operation is performed between IFM [1] (not shown) and the third most significant bit of WT [1] (not shown), . . . , and a logic AND operation is performed between IFM [n] and the third most significant bit of WT [n]. All the results of these logic AND operations are accumulated and shifted by two bits. The other bit of the weight array also undergo the similar procedure. Such procedure can be called as “bit-plane weights processing” since a bit plane of a digital discrete signal (such as image or sound) is a set of bits corresponding to a given bit position in each of the binary numbers representing the signal.

FIG. 4B shows a modified computation for multiplying the IFM data array with the weight array according to the computation shown in FIG. 4A.

As mentioned above with respect to FIG. 4A, a logic AND operation is performed between IFM [0] and the second most significant bit of WT [0] (corresponding to 2³). However, since the second most significant bit of WT [0] is logic zero, the results of the logic AND operation should be zero. To simplify the computation and save unnecessary power consumption, the logic AND operation between IFM [0] and the second most significant bit of WT [0] can be skipped. Similarly, the logic AND operation between IFM [0] and the fifth most significant bit of WT [0], the logic AND operation between IFM [n] and the third most significant bit of WT [n], and the logic AND operation between IFM [n] and the fifth most significant bit of WT [n] can all be skipped. That is, zero-value weight bit within a bit-plane can be skipped in computation.

FIGS. 4C and 4D shows a modified computation for multiplying the IFM data array with the weight array according to the computation shown in FIG. 4B.

In most practical models, the weights are signed. Additionally, due to the sign extension of logic two's complement representation, the number of logic ones in an 8-bit weight creates multiple non-zero sub-weights. Accordingly, it would be efficient to represent the 8-bit signed weights with one sign bit sign and a 7-bit absolute value. Such representation would reduce the number of non-zero sub-weights, and hence reduce the total number of “addition+shift+accumulation.”

The accumulated result should be a large signed value which would have several bits of sign extension. If the accumulator result toggles between positive and negative for each accumulation, the power consumption for sign bit toggling will become significant.

To solve such issues, all the data of positive sub-weights should be accumulated first, and then the data of negative sub-weights are “de-accumulated.” Accordingly, the sign bit toggling may be reduced to only up to one time through all the accumulations. Note that such approach is based on the assumption that the IFM data does not have any negative values, given that Relu functions are normally applied in a previous layer of a neural network.

As shown in FIG. 4C, since the sign bit of WT [n] is logic one, all the sub-weights of WT [n] are negative sub-weights. Accordingly, the data of the positive sub-weights, such as the sub-weights of WT [0], are processed while the data of the negative sub-weights, such as the sub-weights of WT [n], are skipped. The data of the positive sub-weights are accumulated to obtain a positive sum.

As shown in FIG. 4D, since the sign bit of WT [0] is logic zero, all the sub-weights of WT [0] are positive sub-weights. Accordingly, the data of the negative sub-weights, such as the sub-weights of WT [n], are processed while the data of the positive sub-weights, such as the sub-weights of WT [0], are skipped. The data of the negative sub-weights are accumulated to obtain a negative sum.

In accordance with some embodiments of the disclosure, the positive sum and the negative sum are accumulated to obtain a total sum. By doing so, the sign bit toggling may be reduced to only up to one time through all the accumulations.

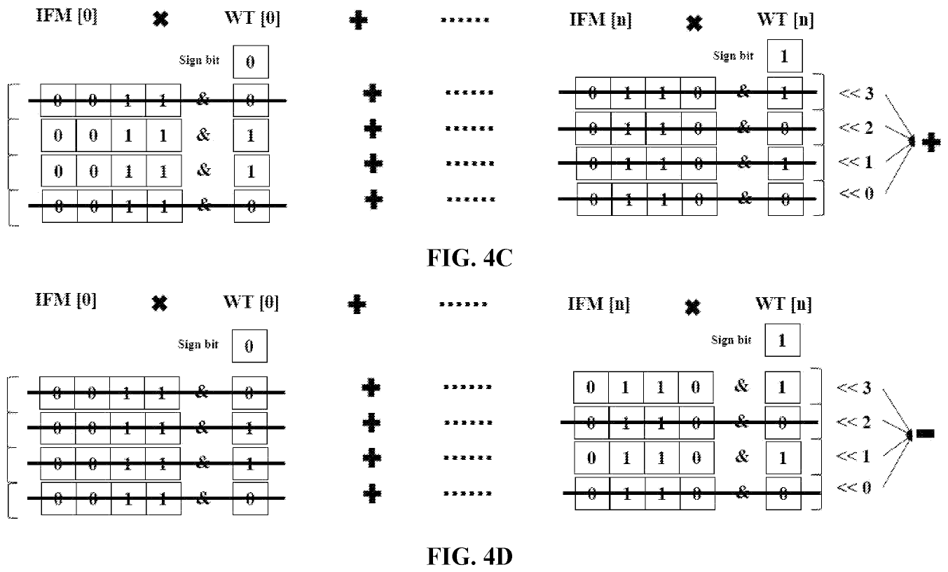

FIG. 5 is a flow chart of a method for convolution calculation in a neural network, in accordance with some embodiments of the present disclosure. In operation 501, each weight is decomposed into multiple sub-weights, each with only one valid bit, in a particular bit significance (bit plane). In operation 502, input feature map units corresponding to each of the sub-weights with the same bit significance are accumulated to obtain intermediate sums. In operation 503, each of the intermediate sums is shifted according to the bit significance of the corresponding sub-weights to obtain shifted intermediate sums. In operation 504, the shifted intermediate sums are further accumulated.

In accordance with some embodiments of the disclosure, each weight further comprises a sign bit, wherein the sign bit can be logic zero (represent positive value) or logic one (represent negative value). In accordance with some embodiments of the disclosure, accumulating the input feature map units to obtain intermediate sums comprises accumulating the input feature map units corresponding to each of the sub-weights with the same valid bit and decomposed from the weights with the sign bit of logic zero to obtain a first set of intermediate sums of the intermediate sums. In accordance with some embodiments of the disclosure, accumulating the input feature map units to obtain intermediate sums comprises accumulating the input feature map units corresponding to each of the sub-weights with the same bit significance and decomposed from the weights with the sign bit of logic one to obtain a second set of intermediate sums of the intermediate sums. In accordance with some embodiments of the disclosure, accumulating the shifted intermediate sums comprises: accumulating the shifted intermediate sums of the first set of intermediate sums to obtain a first sum; and after obtaining the first sum, accumulating the shifted intermediate sums of the second set of intermediate sums to the first sum to obtain a second sum.

In accordance with some embodiments of the disclosure, the one valid bit is logic one and the bits other than the valid bit of each of the sub-weights are logic zero. In accordance with some embodiments of the disclosure, the weights and the sub-weights are binary codes including the same number of bits.

In accordance with some embodiments of the disclosure, shifting each of the intermediate sums according to the valid bit of the corresponding sub-weight comprises: if the valid bit of the corresponding sub-weights is the bit representing 22, then the intermediate sum is shifted N digits. In accordance with some embodiments of the disclosure, the weights with the sign bit of logic one are in logic two's complement representation. In accordance with some embodiments of the disclosure, each weight is decomposed into N sub-weights if the weight include N bits of logic one.

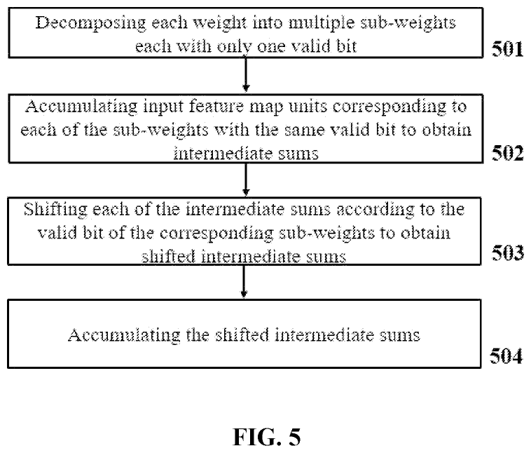

FIG. 6 illustrates a time diagram of the accumulator value, in accordance with some embodiments of the present disclosure. The time diagram of FIG. 6 shows an example of the accumulator value without separately accumulating the data of positive sub-weights and the data of negative sub-weights. The accumulator value toggles between positive and negative several times in FIG. 6. Such toggling may consume a significant amount of power during the accumulation.

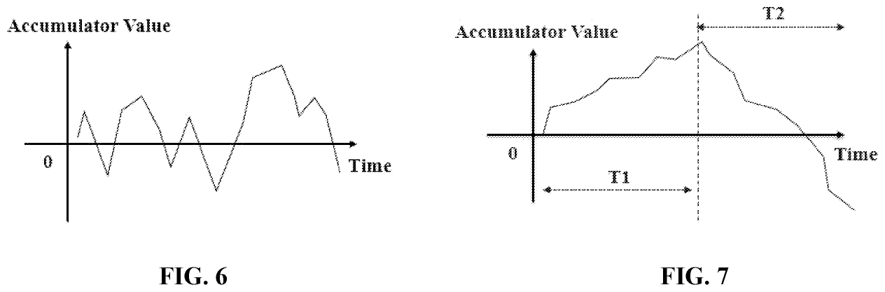

FIG. 7 illustrates a time diagram of the accumulator value, in accordance with some embodiments of the present disclosure. The time diagram of FIG. 7 shows an example of the accumulator value along with separately accumulating the data of positive sub-weights and the data of negative sub-weights. During the time period T1, the data of positive sub-weights is added to the accumulator value. During the time period T2, the data of negative sub-weights is “de-accumulated” from the accumulator value. As a result, the accumulator value only toggles once from positive to negative in FIG. 7.

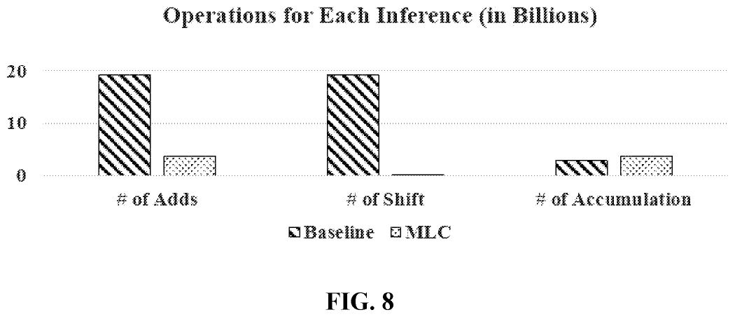

FIG. 8 illustrates a diagram showing the comparison between the baseline approach and the MLC approach, in accordance with some embodiments of the present disclosure. The comparison is based on estimations with operation counts in one YOLO v3 inference (in billions). For comparison, an 8-bit×8-bit multiplier in the baseline approach is broken down into eight add operations and eight shift operations. As shown in FIG. 8, the total number of adding operations for the baseline approach is more than 5 times that of the MLC approach. The total number of shifting operations for the baseline approach is more than 750 times that of the MLC approach. Although more accumulations are involved for the MLC approach, the number of accumulations for the MLC approach merely grows by less than 30% of the number of accumulations for the baseline approach. The total power consumption of the baseline approach is more than four times that of the MLC approach.

According to the present disclosure, bit-plane weights processing for convolution acceleration is achieved by breaking the boundary of the basic multi-bit multiplier circuits. Only one shift is performed for each of the bit-planes after the accumulation is done for the bit-plane. The processing of bit-plane weights reduces the number of shift operations by N times for a convolution with N number of multiplications. Since shifting uses power as data are toggling (i.e., logic one to logic zero, and vice versa), the processing of bit-plane weights saves power for convolution.

Additionally, according to the present disclosure, weight bits with logic zero within a bit-plane are skipped in computation. For example, logic zero bits within a non-zero 8-bit weight can be exploited to save power. Accordingly, a neural network model can use more bits for weights so as to achieve better artificial intelligence (AI) accuracy without consuming significant power since only the non-zero bits within each of the weights are actually counted.

Moreover, grouping all positive weight bit-planes for accumulation before “de-accumulating” the negative weight bit-planes can also help save power. The accumulated result can only swing once from positive to negative for the entire accumulation. In some embodiments of the disclosure, all the negative weight bit-planes can also be “de-accumulated” first before accumulating the positive weight bit-planes, so that the accumulated result would only swing once from negative to positive for the entire accumulation.

The present disclosure can be applied to an AI-based video processor. Since bit-plane processing can reduce total power consumption, the AI developer will not need to restrict their weight precision to lower bit-width. For example, 3-bit or 4-bit weights may be used to reduce the power consumption for processing. However, 3-bit or 4-bit weights may only provide limited AI accuracy. With bit-plane processing, weights with more bits, such as 8-bit weights, can be applied.

The foregoing outlines features of several embodiments so that those skilled in the art may better understand aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for convolution calculation in a neural network, comprising:
decomposing each weight into multiple sub-weights, each with only one valid bit, in a particular bit significance;
accumulating input feature map units corresponding to each of the sub-weights with the same bit significance to obtain intermediate sums;
shifting each of the intermediate sums according to the bit significance of the corresponding sub-weights to obtain shifted intermediate sums; and
accumulating the shifted intermediate sums.

2. The method according to claim 1, wherein each weight further comprises a sign bit, wherein the sign bit can be logic zero for representing positive value or logic one for representing negative value.

3. The method according to claim 2, wherein accumulating the input feature map units to obtain intermediate sums comprises accumulating the input feature map units corresponding to each of the sub-weights with the same bit significance and decomposed from the weights with the sign bit of logic zero to obtain a first set of intermediate sums of the intermediate sums.

4. The method according to claim 3, wherein accumulating the input feature map units to obtain intermediate sums comprises accumulating the input feature map units corresponding to each of the sub-weights with the same bit significance and decomposed from the weights with the sign bit of logic one to obtain a second set of intermediate sums of the intermediate sums.

5. The method according to claim 4, wherein accumulating the shifted intermediate sums comprises:
accumulating the shifted intermediate sums of the first set of intermediate sums to obtain a first sum; and
after obtaining the first sum, accumulating the shifted intermediate sums of the second set of intermediate sums with respect to the first sum to obtain a second sum.

6. The method according to claim 1, wherein the one valid bit is logic one and the bits other than the valid bit of each of the sub-weights are logic zero.

7. The method according to claim 1, wherein the weights and the sub-weights are binary codes including the same number of bits.

8. The method according to claim 7, wherein shifting each of the intermediate sums according to the valid bit of the corresponding sub-weight comprises: if the valid bit of the corresponding sub-weights is the bit representing 2^{N}, then the intermediate sum is shifted N digits.

9. The method according to claim 2, wherein the weights with the sign bit of logic one are in logic two's complement representation.

10. The method according to claim 7, wherein each weight is decomposed into N sub-weights if the weights include N bits of logic one.

11. An apparatus for convolution calculation in a neural network, comprising:
a computing device configured to decompose each weight into multiple sub-weights, each with only one valid bit, in a particular bit significance;
a first accumulator configured to accumulate input feature map units corresponding to each of the sub-weights in a particular bit significance from the computing device to obtain intermediate sums;
a shifter configured to shift each of the intermediate sums according to the bit significance of the corresponding sub-weights from the computing device to obtain shifted intermediate sums;
a second accumulator configured to accumulate the shifted intermediate sums.

12. The apparatus according to claim 11, wherein each weight further comprises a sign bit, wherein the sign bit can be logic zero for representing positive value or logic one for representing negative value.

13. The apparatus according to claim 12, wherein the first accumulator accumulates the input feature map units corresponding to each of the sub-weights with the same bit significance and decomposed from the weights with the sign bit of logic zero to obtain a first set of intermediate sums of the intermediate sums.

14. The apparatus according to claim 13, wherein the first accumulator accumulates the input feature map units corresponding to each of the sub-weights with the same bit significance and decomposed from the weights with the sign bit of logic one to obtain a second set of intermediate sums of the intermediate sums.

15. The apparatus according to claim 14, wherein the second accumulator further:
accumulates the shifted intermediate sums of the first set of intermediate sums from the shifter to obtain a first sum; and
after obtaining the first sum, accumulates the shifted intermediate sums of the second set of intermediate sums from the shifter to the first sum to obtain a second sum.

16. The apparatus according to claim 11, wherein the one valid bit is logic one and the bits other than the valid bit of each of the sub-weights are logic zero.

17. The apparatus according to claim 11, wherein the weights and the sub-weights are binary codes including the same number of bits.

18. The apparatus according to claim 17, wherein if the valid bit of the corresponding sub-weights of one of the intermediate sums is the bit representing 2^{N}, then the intermediate sum is shifted N digits by the shifter.

19. The apparatus according to claim 12, wherein the weights with the sign bit of logic one are in logic two's complement representation.

20. The apparatus according to claim 17, wherein the computing device decomposes each weight into N sub-weights if the weight includes N bits of logic one.

21. An arithmetic logic unit for a neural network, comprising:
a first register;
a first adder configured to add an input feature map unit with a first value stored in the first register and update the first value stored in the first register;
a shifter configured to shift an output of the register a predetermined number of bits;
a second register; and
a second adder configured to add an output of the shifter with a second value stored in the second register and update the second value stored in the second register.

22. The arithmetic logic unit according to claim 21, further comprising a first multiplexer configured to select the input feature map unit from input feature map data and forward the input feature map unit to the first adder.

23. The arithmetic logic unit according to claim 21, further comprising a second multiplexer configured to select between an output of the second register and a partial sum from an adjacent arithmetic logic unit and forward it to the second adder.
